(19) United States
(12) Patent Application Publication
(10) Pub. No.: US 2004/0062784 A1
(43) Pub. Date: Apr. 1, 2004

(54) Ant proof device

(76) Inventor: Chen-Hung Huang, Changhua Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/667,343

(22) Filed: Sep. 23, 2003

(30) Foreign Application Priority Data
Sep. 26, 2002 (TW) 091215410

(51) Int. Cl. A01N 25/08

(52) U.S. Cl. 424/409

(57) ABSTRACT

An ant proof device includes an annular grooved body and a talcum powder product. The annular grooved body has a bottom face, an inner circumferential wall and an outer circumferential wall that form a receptacle. The nontoxic talcum powder product is contained in the receptacle for preventing ants from crawling through the annular grooved body. The talcum powder product is not volatile so that it is unnecessary to frequently supplement the talcum powder product. Also, children or pets will not accidentally get toxic. Its structure is simple and can be manufactured at low cost. A dustproof lid can be used with the ant proof device to prevent dust or water from dropping onto the surface of the talcum powder product.

### BACKGROUND OF THE INVENTION

The present invention is related to an ant proof device, and more particularly to an ant proof device utilizing talcum powder product for isolating ants. It is unnecessary to frequently supplement the talcum powder product. The talcum powder product is nontoxic so that the safety in use can be ensured. In addition, the ant proof device has simple structure and is manufactured at low cost.

There are various conventional ant proof devices. These ant proof devices can be substantially divided into three types as follows:

The first type utilizes water to isolate ants as shown in FIGS. 1 and 2. The structure includes a barrel body 71 and a tray body 72 detachably connected with the bottom of the barrel body 71 by means of insertion. The tray body 72 has an annular water reservoir 73 in which water (not shown) is contained for isolating ants. Such product is disadvantageous in that the water tends to volatilize or vaporize so that the water will become shallower and shallower. In the case that a user forgets to supplement water into the tray body 72, there may be no water in the tray body 72 and ants can crawl over the tray body 72. Another shortcoming of the above structure is that when the device is positioned on an inclined place, the depth of the water in the water reservoir 73 will be uneven. Therefore, some part of the water reservoir 73 may be dry, permitting ants to crawl through.

The second type utilizes chemical which can release an odor for repelling ants as shown in FIG. 3. An ant repellant 83 is disposed between an article seat 81 and a base seat 82 for releasing a chemical ant-repelling odor to repel ants. However, such ant repellant 83 generally smells badly or even is toxic. If a child or a pet touches the ant repellant, an accident may take place. In addition, the ant repellant 83 continuously releases the odor so that it is necessary to periodically replace the ant repellant 83. It is troublesome to purchase and replace the ant repellant 83.

The third type utilizes electricity to isolate ants as shown in FIG. 4. Such structure includes an upper tray 91, a lower tray 92, several grid-shaped circuit boards 93, several columns 94 and a power source 95. Positive and negative power (9 to 40 volts) is applied to the grid-shaped circuit boards 93. When ants crawl over the circuit boards 93, short circuit is caused to kill the ants. However, such structure has a shortcoming that short circuit may be accidentally caused, for example, when water is splashed onto the circuit board. Besides, it is necessary to continuously supply power for the device. This limits the location of the device and increases using cost thereof (for the transformer or cells).

### SUMMARY OF THE INVENTION

It is therefore a primary object of the present invention to provide an ant proof device. Ants cannot freely crawl on the talcum powder product. Accordingly, talcum powder product is placed in an annular grooved body of the ant proof device to isolate ants. It is unnecessary to frequently supplement the talcum powder product.

It is a further object of the present invention to provide the above ant proof device in which the talcum powder product is nontoxic so that children or pets will not accidentally get toxic and the safety can be ensured. Also, the nontoxic talcum powder product will not lead to problem of environmental protection.

It is still a further object of the present invention to provide the above ant proof device that has simple structure and is manufactured at low cost.

According to the above objects, the ant proof device includes an annular grooved body and a predetermined volume of talcum powder product. The annular grooved body has a bottom face, an inner circumferential wall and an outer circumferential wall which define a receptacle. The receptacle has an opening facing upward. The talcum powder product includes numerous nontoxic solid particles. The talcum powder product is placed in the receptacle of the annular grooved body for preventing ants from crawling through the annular grooved body.

The present invention can be best understood through the following description and accompanying drawings wherein:

### BRIEF DESCRIPTION OF THE DRAWINGS

FIG. 1 is a perspective view of a first type of conventional ant proof device;

FIG. 2 is a sectional assembled view of the first type of conventional ant proof device;

FIG. 3 is a sectional assembled view of a second type of conventional ant proof device;

FIG. 4 is a front view of a third type of conventional ant proof device;

FIG. 5 is a perspective view of a first embodiment of the ant proof device of the present invention;

FIG. 6 is a perspective view of a second embodiment of the ant proof device of the present invention;

FIG. 7 is a perspective exploded view of a third embodiment of the ant proof device of the present invention;

FIG. 8 is a sectional view of the third embodiment of the ant proof device of the present invention;

FIG. 9 is a sectional view of a fourth embodiment of the ant proof device of the present invention; and

FIG. 10 shows another application of the ant proof device of the present invention.

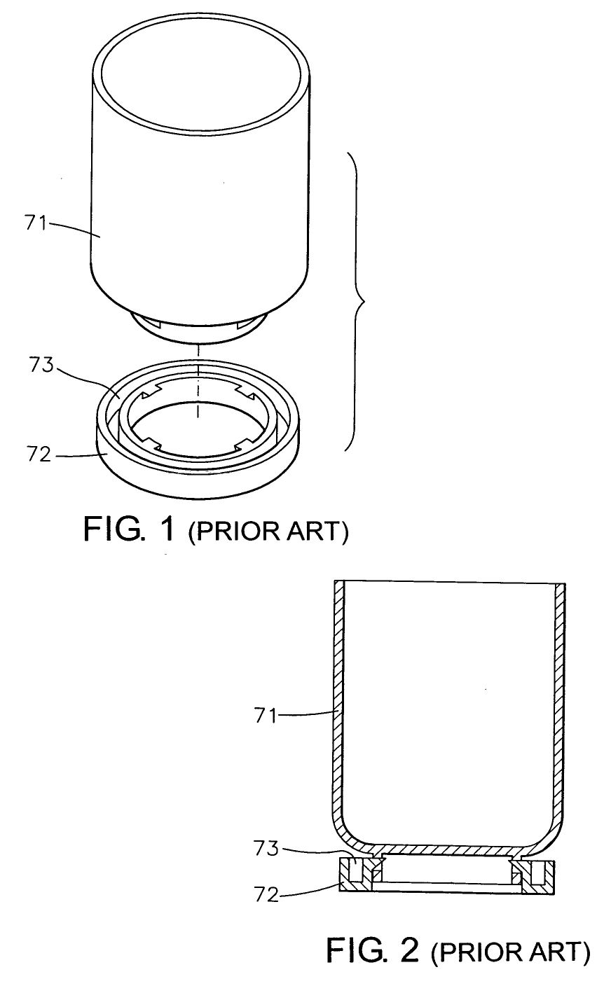

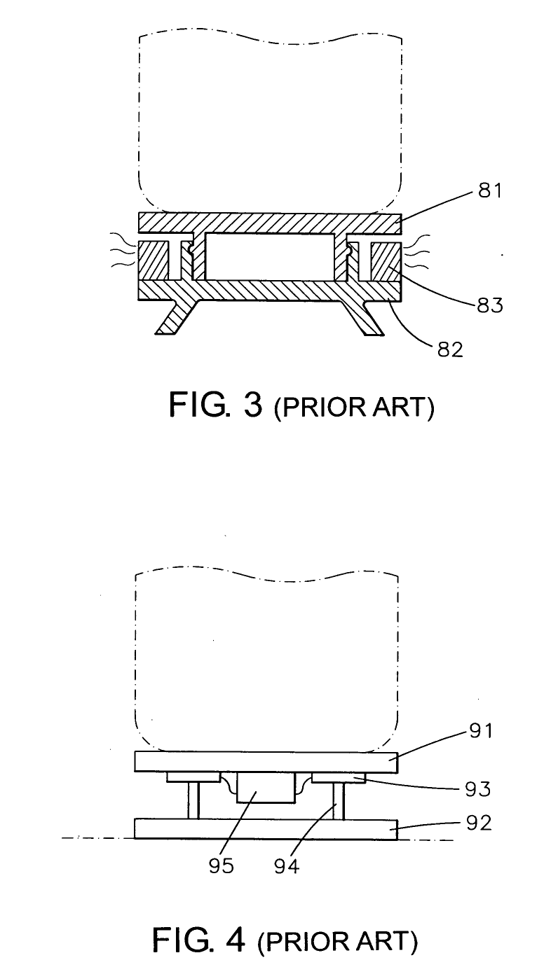

### DETAILED DESCRIPTION OF THE PREFERRED EMBODIMENTS

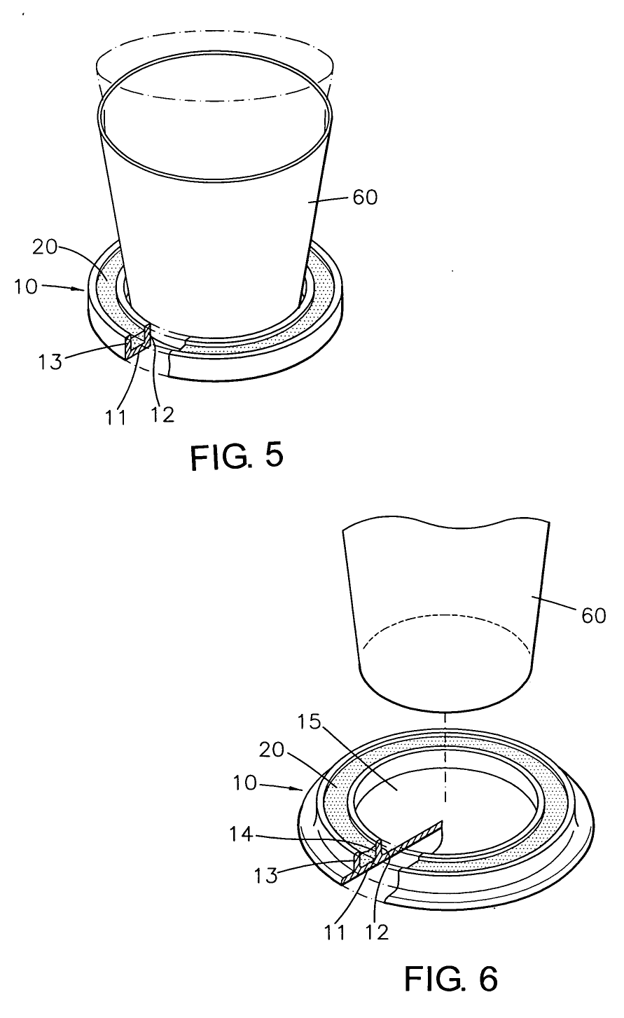

Referring to FIG. 5, according to a first embodiment, the ant proof device of the present invention includes an annular grooved body 10 having a bottom face 11, an inner circumferential wall 12 and an outer circumferential wall 13 which define a receptacle 14 (referring to FIGS. 6 to 8). The receptacle 14 has an opening facing upward. The annular grooved body 10 is substantially a plane body and can be horizontally placed on the ground or a table face. Practically, when it is seen from the top, the annular grooved body 10 can be circular, elliptic, polygonal or other shape.

A predetermined volume of talcum powder product 20 including numerous nontoxic solid particles is placed in the receptacle 14 of the annular grooved body 10. The talcum powder product 20 is preferably daily used prickly heat powder. (The major component of the prickly heat powder is talcum powder and the subsidiary components are incense and additives.) Alternatively, the talcum powder product 20 can be any other product the major component of which is talcum powder.

A garbage can 60 (or a dish of foods) can be placed in the inner circumferential wall 12. The residuals contained in the garbage can 60 will attract ants to get close. When the ants go near to the present invention, the ants will first crawl onto the outer circumferential wall 13 of the annular grooved body 10 and then try to get closer to the garbage can 60. However, the talcum powder product 20 is contained in the receptacle 14 of the annular grooved body 10 so that the ants cannot crawl through. Therefore, the ants are prevented from crawling into the garbage can 60.

In the case that the prickly heat powder is used as the talcum powder product 20, it is easy to obtain the talcum powder product 20. (The prickly heat powder is sold in all the drug stores, convenience stores and shopping malls.) Moreover, the prickly heat powder is cheap and nontoxic without possibility of hurting children or pets. In addition, the talcum powder product 20 is solid and will not gradually evaporate as water. Therefore, it is unnecessary to frequently supplement the annular grooved body 10 with talcum powder product.

FIG. 6 shows a second embodiment of the present invention, which includes the same annular grooved body 10 and talcum powder product 20 as the first embodiment. In addition, a plane board section 15 inward horizontally extends from the annular grooved body 10 to form an integrated body which has more rigid structure.

In use, the garbage can 60 (or a dish of foods) can be placed on the plane board section 15.

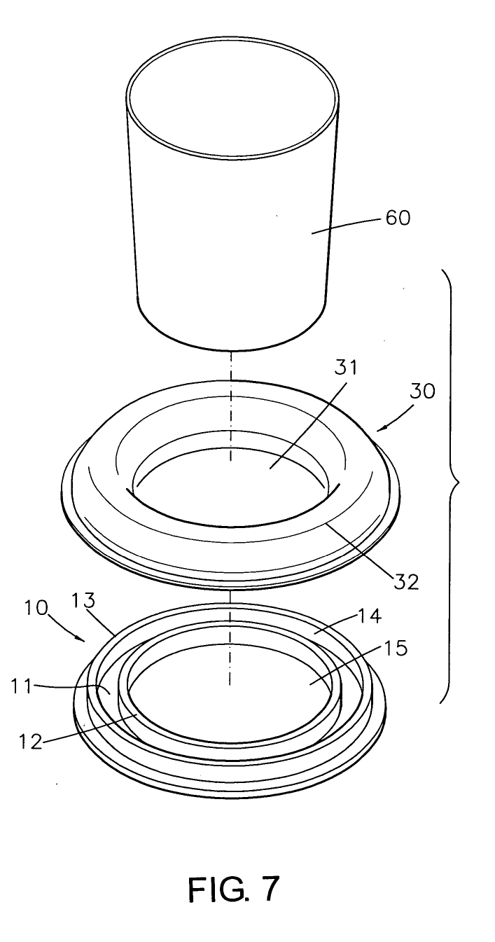

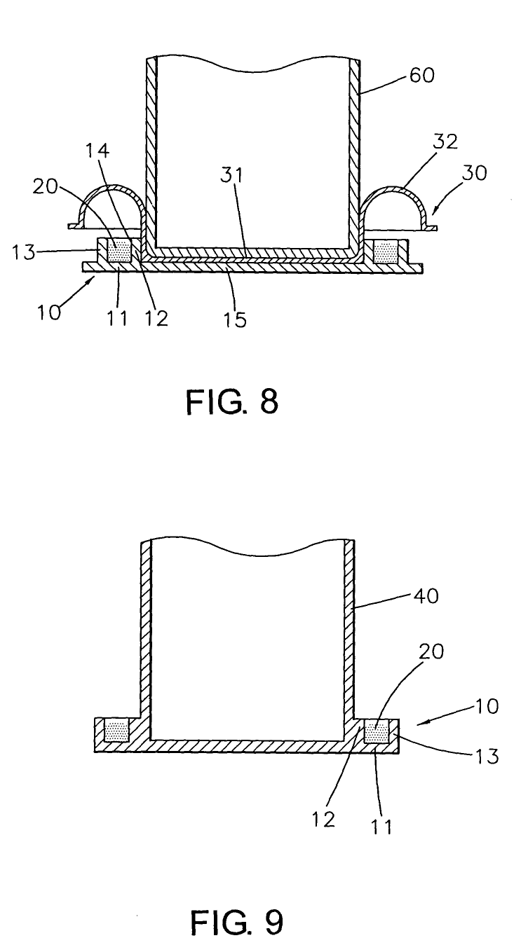

FIGS. 7 and 8 show a third embodiment of the present invention, which includes the same annular grooved body 10 and talcum powder product 20 as the second embodiment. The third embodiment further includes a dustproof lid 30 having a central section 31 and a cover section 32 outward extending from the central section 31. The cover section 32 is positioned in a predetermined position above the annular grooved body 10 without contacting with the talcum powder product 20 and the outer circumferential wall 13.

The dustproof lid 30 prevents dust or water from dropping onto the surface of the talcum powder product 20. In addition, the dustproof lid 30 beautifies the appearance of the present invention.

FIG. 9 shows a fourth embodiment of the present invention, in which a container 40 inward extends from the annular grooved body. The container 40 can be a garbage can, a dish or other container.

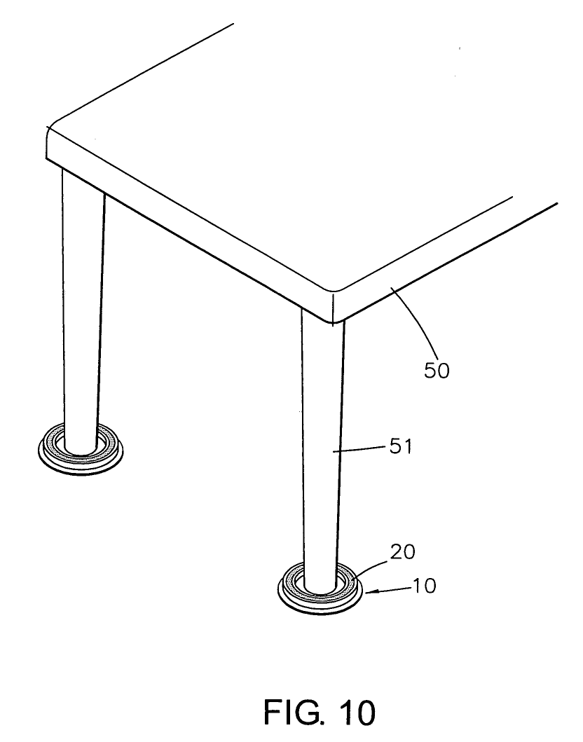

The present invention is also applicable to the leg 51 of a dining table 50 as shown in FIG. 10. In this case, the size of the present invention is minified to adapt the ant proof device to the leg 51 of the dining table 50. Similarly, ants are prevented from crawling from the ground up to the dining table 50.

In some special cases that it is necessary to raise or observe ants, ants can be placed in the inner circumferential wall 12 (of the first and second embodiments) and prevented from escaping.

In conclusion, the present invention has the following advantages:

1. It is unnecessary to frequently replace the talcum powder product. The talcum powder product used in the present invention is not volatile so that it is unnecessary to frequently supplement the talcum powder product. Even though it is necessary to replace the talcum powder product, it is easy to purchase the talcum powder product in all ordinary drug stores and shopping malls.

2. The talcum powder product is nontoxic so that children or pets will not accidentally get toxic and the safety can be ensured.

3. The ant proof device of the present invention has simple structure and is manufactured at low cost. Therefore, the ant proof device of the present invention is strongly competitive on market.

The above embodiments are only used to illustrate the present invention, not intended to limit the scope thereof. Many modifications of the above embodiments can be made without departing from the spirit of the present invention.

What is claimed is:

1. An ant proof device comprising:
an annular grooved body having a bottom face, an inner circumferential wall and an outer circumferential wall that define a receptacle, the receptacle having an opening facing upward; and
a predetermined volume of talcum powder product including numerous nontoxic solid particles, the talcum powder product being placed in the receptacle of the annular grooved body for preventing ants from crawling through the annular grooved body.

2. The ant proof device as claimed in claim 1, wherein a plane board section inward horizontally extends from the annular grooved body.

3. The ant proof device as claimed in claim 2, further comprising a dustproof lid having a central section and a cover section outward extending from the central section, the cover section being positioned in a predetermined position above the annular grooved body without contacting with the talcum powder product and the outer circumferential wall.

4. The ant proof device as claimed in claim 1, wherein a container inward extends from the annular grooved body.

5. The ant proof device as claimed in claim 1, wherein the talcum powder product is prickly heat powder.
